(19) United States
(12) Patent Application Publication
(10) Pub. No.: US 2019/0260708 A1
(43) Pub. Date: Aug. 22, 2019

(54) TEXT-BASED TELEPHONIC SYSTEM

(71) Applicant: Abdullah Khalid Alrasheed, Riyadh (SA)

(72) Inventor: Abdullah Khalid Alrasheed, Riyadh (SA)

(21) Appl. No.: 15/900,990

(22) Filed: Feb. 21, 2018

(51) Int. Cl. H04L 29/12; H04M 3/42; H04M 7/00; H04M 1/2745; G06F 17/30

(52) U.S. Cl. CPC H04L 61/1594; H04M 3/42306; H04M 7/003; H04M 2203/256; H04M 1/27455; G06F 17/30867; G06F 17/30985; H04M 1/274516

(57) ABSTRACT

A text-based telephonic system includes a database containing entries for text strings and corresponding telephone numbers. Telephone numbers corresponding to respective text strings are retrieved from the database. For instance, responsive to a phone providing a text string, the database is accessed to provide the corresponding telephone number to the phone. The provided telephone number would be usable by the phone to connect to a second phone via a telephony network. The text strings can be words or alphanumeric strings, which greatly enhances memory compared to numeric telephone numbers. The connection between the phones comprises a telephone call using a telephony network such as a public-switched telephone network or the Internet using Voice over Internet Protocol (VoIP) technology.

### BACKGROUND OF THE INVENTION

### 1. Field of the Invention

The present invention relates to a system for dialing phone numbers using text or alphanumeric strings instead of numbers.

### 2. Description of the Related Art

A typical telephone number is divided into a 3-digit area code, a 3-digit central office prefix, and a 4-digit line number. As an example, the telephone number 123-456-7890 would include area code “123”, central office prefix “456”, and line number “7890”. Memorizing seven to ten serial digits, like in telephone numbers, is very difficult for the human brain, which prefers words and images. Indeed, studies have shown that more than half of adults do not remember their spouse's cell number. 70 percent of respondents also could not remember their best friend's phone number, and 51 percent could not recall their parent's number.

Because of the difficulty of remembering lengthy numbers, many people keep an “address book” that lists personal contacts, including phone numbers, usually in contact name order. Although useful, such address books require the user to have the book and a writing instrument available when the person provides their contact information. More recently, digital versions of address books have become available, but these require a certain amount of discipline to use, and when the user buys a new phone, contact information must be transferred—which is not always an easy task.

In an effort to get customers to remember their phone number, some businesses use vanity telephone numbers in which the user dials a word instead of a series of numbers. For example, the user might dial “1-800-FLOWERS” instead of “1-800-356-9377.” This is accomplished since numbers on a standard phone handset are each associated with several letters (e.g., the number 3 is associated with letters D, E, and F). Although useful, such vanity numbers are expensive to obtain, limited in availability, and must be exactly seven letters. Vanity numbers can be applied to less than one percent of telephone numbers only.

### SUMMARY OF THE INVENTION

A text-based telephonic system includes a database containing entries for text strings and corresponding telephone numbers. Telephone numbers corresponding to respective text strings are retrieved from the database. For instance, responsive to a phone providing a text string, the database is accessed to provide the corresponding telephone number to the phone. The provided telephone number would be usable by the phone to connect to a second phone via a telephony network. The text strings can be words or alphanumeric strings, which greatly enhances memory compared to numeric telephone numbers. The connection between the phones comprises a telephone call using a telephony network such as a public-switched telephone network or the Internet using Voice over Internet Protocol (VoIP) technology.

In an embodiment, at least part of the database is stored in memory of the phone, which may be a smart phone or the like, and the processor used to retrieve the corresponding telephone number is the processor of the smart phone. In this case, the database stored in the memory of the smart phone may only include a subset of the entire database, such as all the telephone numbers within a particular area code. If the provided text string cannot be found in the database stored in memory of the phone, another database (remote to the first smart phone) may be consulted.

In an embodiment, the first phone can access a search engine that allows the user to find the appropriate text string for the person or business that the user wishes to call. In this case, the search engine provides a list of relevant results related to the search engine query. These results can include personal information relating to one or more individuals or information regarding a business or organization. In certain cases, graphical information, such as images and/or videos can be presented. The search engine query can include keywords such a name (or nickname) of a person, company, or organization; location information; product or service information; and so forth. In an embodiment, the text strings can include trademarks of a product or service or a domain name.

### BRIEF DESCRIPTION OF THE DRAWINGS

FIG. 1 illustrates a text-based telephonic system, according to an embodiment.

FIG. 2 illustrates an exemplary data structure usable in conjunction with the text-based telephonic system, according to an embodiment.

FIG. 3 illustrates an exemplary search engine usable in conjunction with the text-based telephonic system, according to an embodiment.

FIG. 4 illustrates an exemplary smart phone usable in conjunction with the text-based telephonic system, according to an embodiment.

FIGS. 5-7 are diagrams showing various methods of use of the text-based telephony system.

### DETAILED DESCRIPTION OF THE INVENTION

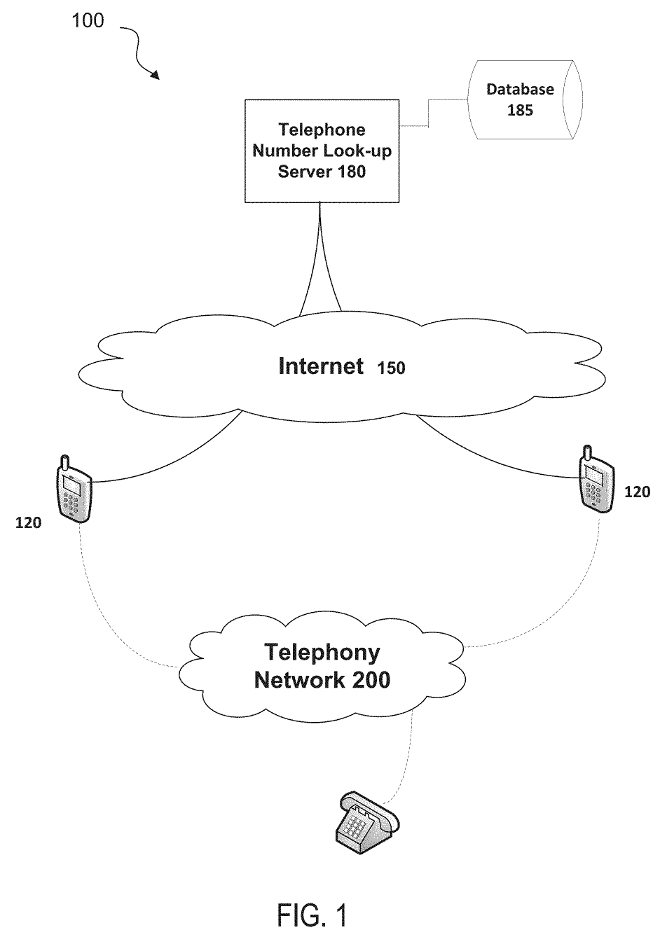

Referring to FIG. 1, an exemplary text-based telephonic system 100, according to an embodiment, is illustrated. As shown, the text-based telephonic system 100 includes a plurality of smart phones 120 that are coupled via the Internet 150 to a telephone number look-up server 180. The telephone number look-up server 180 manages a database 185 containing entries for text strings and corresponding telephone numbers. Each smart phone 120 includes both computing and telephone communication capabilities. As shown, there are two smart phones 120, however, it is to be understood that the text-based telephonic system 100 is capable of supporting many more such devices. Additionally, a telephony network 200 such as a public-switched telephone network or a cellular network is depicted such that a caller using a smart phone 120 can initiate a telephone call to either another smart phone 120 or a “dumb” telephone 140 which may be a landline or a simple cell phone.

As will be described in greater detail, instead of using a numeric telephone number to place (“dial”) a telephone, a caller can use a more easy to remember text string comprising text or an alphanumeric. As an example, the text string “BENZ” can be assigned to a numeric telephone number. In this case, the owner of the telephone number would have registered the text string “BENZ” with the text-based telephonic system 100, and the database 185 would be updated with information regarding the text string “BENZ” and the corresponding numeric telephone number. During the registration process, a check of the database 185 would be undertaken to ensure that the requested text string was not already taken. If it was determined that the text string was already registered, another such text string would have to be chosen. In an embodiment, the caller would have an application (computer program) installed on his or her smart phone 120, and the caller would enter (e.g., type or select) the desired text string (e.g., “BENZ”) instead of dialing a numeric telephone number. The smart phone 120 of the caller would connect with the telephone number look-up server 180 via the Internet 150, and the telephone number look-up server 180 would thereupon consult the database 185 for a match. The telephone number associated with the input text string would be sent from the telephone number look-up server 180 via the Internet 150 to the smart phone 120 of the caller. Once the telephone number is received, the application executing on the smart phone 120 of the caller would use the telephone number to place a call to the callee. The call would take place via telephony network 200. The telephony network 200 would be one or more suitable telephone network such as a public-switched telephone network, a cellular network, or the Internet using Voice over Internet Protocol (VoIP) technology. (In the case of VoIP, the call would connect via the Internet 150 instead of the telephony network 200.)

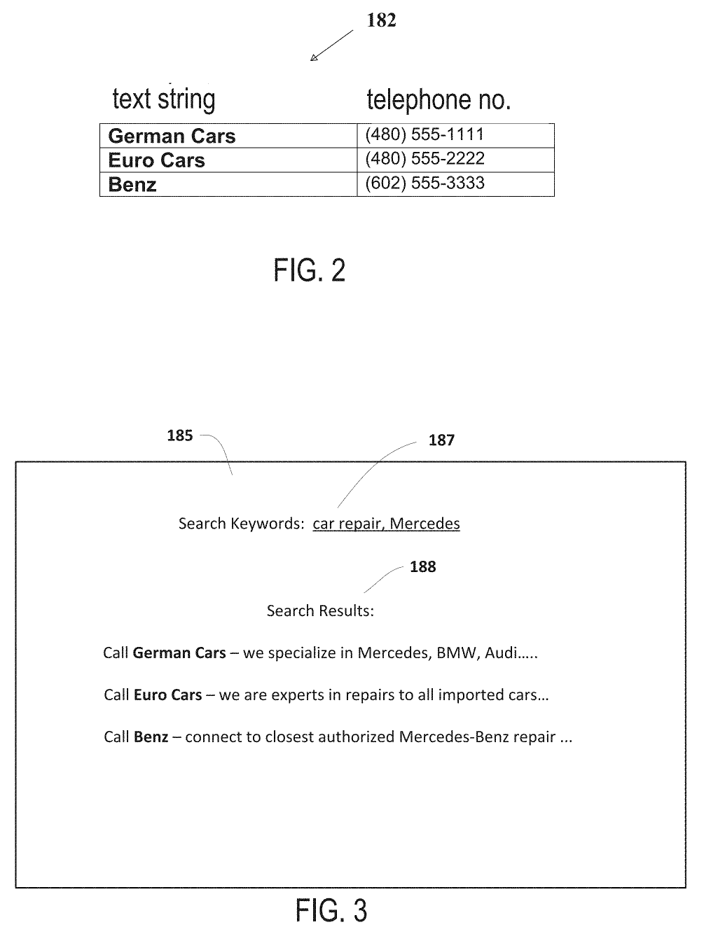

FIG. 2 illustrates an exemplary data structure 182 usable in conjunction with the text-based telephonic system 100, according to an embodiment. As shown, the data structure 182 includes a first column labeled “text string” and a second column labeled “telephone no.” As illustrated, there is a one-to-one relationship between “text string” and “telephone no.” though it is also possible to have a one-to-many relationship in which there are several numeric telephone number associated with a particular text string. For instance, the string “Euro Cars” could result in several telephone numbers being returned. Finally, it is to be understood that the telephone number could be divided into a separate area code and/or include other pertinent information, such as a country code for international dialing.

FIG. 3 illustrates an exemplary search engine interface usable in conjunction with the text-based telephonic system 100, according to an embodiment. As noted, the ability to utilize a text-based telephone indicator greatly facilitates memory. However, there are times where one may not remember or know the text string associated with a person or business. Accordingly, a “search engine” tool such as the one depicted in FIG. 3 would be useful. As shown, the user enters keywords 187 and pertinent search results related to the keywords 187 are displayed as search results 188. There are numerous known methods to provide searching, including structured searching which requires the user to enter search queries in a particular syntax and unstructured searching in which the keywords are entered as free form text. As shown, the keywords 187 are unstructured. The search engine tool may use any known or later developed methods/algorithms to provide pertinent search results. As illustrated, the user has entered the keywords 187 “car repair” and “Mercedes,” separated by a comma to find car repair shops capable of repairing a Mercedes-Benz vehicle. The search engine can be provided with the current location of the smart phone 120, so the search results 188 may include several nearby repair shops. Instead of numeric telephone numbers, the search results 188 include the text strings “German Cars,” “Euro Cars,” and “Benz,” for each car repair shop found in the search. As indicated, the search results 188 include information regarding each of these businesses. It is to be understood that other such information, including the address, web site, and hours of operation could also be listed. Additionally, it is to be understood that although the example shows business-related information, the search engine tool could also be used to provide search results relating to queries for individuals. In such cases, the search engine results could include a photo (digital image) of one or more persons found in the search. In various embodiments, the search engine tool can interface with one or more social network such as Facebook, Twitter, and LinkedIn, to provide such information in the search results. Furthermore, search engine optimization (SEO) can be used, to prioritize the searched keyword(s) or frequently called business or company, to obtain higher ranking placement in search results. In an embodiment, such prioritization can be done for a fee.

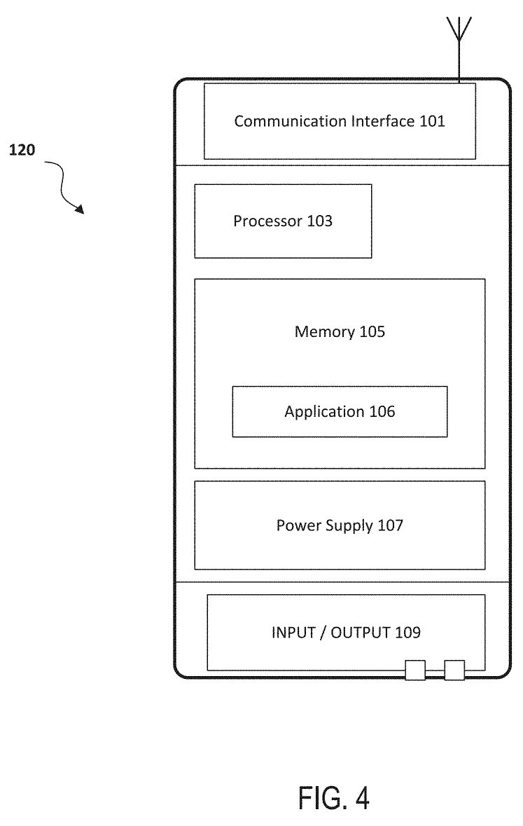

FIG. 4 shows a block diagram of a typical smart phone 120 useable in conjunction with the text-based telephonic system 100, according to an embodiment. As depicted, the computing device 120 includes a communication interface 101, a processor 103, memory 105, a power supply 107, and input/output 109. In an embodiment, the communication interface 101 includes a cellular transmitter and receiver. The processor 103 includes a central processing unit (CPU). The memory can include ROM/RAM, flash memory and the like. The power supply 109 can include a re-chargeable battery and power charger. Application 106 is stored in the memory 105, and includes program code non-transitorily embedded thereon. This program code includes various programs executable by the processor 103 to interface with the telephone number look-up server 180, such as to obtain numeric telephone numbers from provided text-based telephone indicators. As will be explained in greater detail, the memory 105 can also include a local database having a subset of entries for a local geographic area, such as all of the entries within the local area code. In general, the application 106 will include the software of the invention to effect the “client-side” methods described herein. In some cases, the software will include software that comes with the computing device 120 or was installed previously.

The text-based telephonic system 100 includes a distributed application which is partitioned between a service provider (telephone number look-up server 180) and a plurality of service requesters (smart phones 120). Under this arrangement, a request-response protocol, such as hypertext protocol (HTTP), can be employed such that a client (smart phone 120) can initiate requests for services from the server 180, and the server 180 can respond to each respective request by, for example, executing an application, and (where appropriate) sending results to the client (smart phones 120). The server 80 can also include the database 185 and a logic engine operatively linked to the server 180, allowing the application to query and store data therein. It is to be understood that in some embodiments, however, substantial portions of the application logic may be performed on the client using, for example, the AJAX (Asynchronous JavaScript and XML) paradigm to create an asynchronous web application. Furthermore, it is to be understood that in some embodiments the application can be distributed among a plurality of different servers (not shown).

In the present description of the present invention, exemplary methods for performing various aspects of the present invention are disclosed. It is to be understood that the steps illustrated herein can be performed by executing computer program code written in a variety of suitable programming languages, such as C, C++, C#, Visual Basic, and Java. It is also to be understood that the software of the invention will preferably further include various Web-based applications that can be written in HTML, PHP, Javascript, jQuery, etc., accessible by the clients using a suitable browser 145 (e.g., Internet Explorer, Microsoft Edge, Mozilla Firefox, Google Chrome, Safari, Opera) or as an application running on a suitable mobile device (e.g., an iOS or Android “app”).

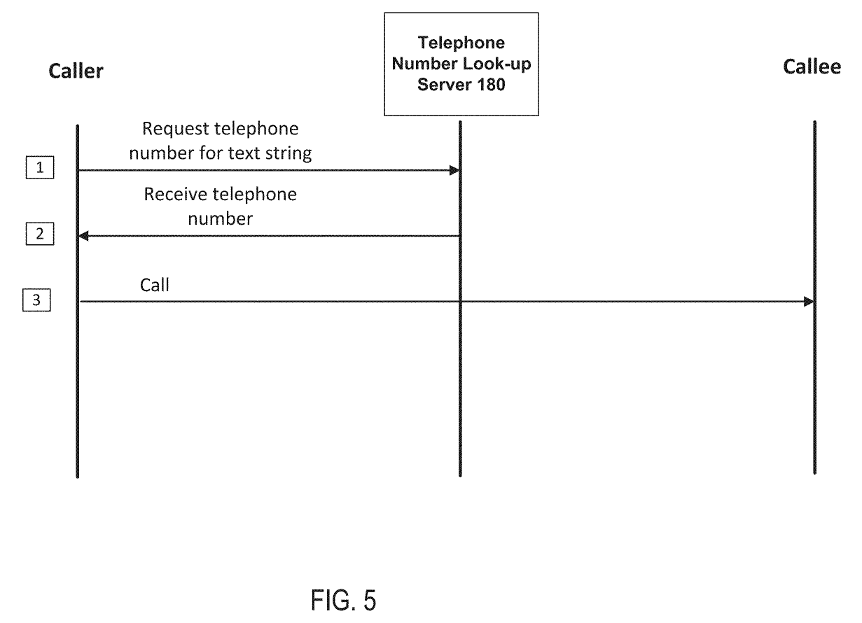

FIG. 5 is a diagram showing a method of using the text-based telephony system 100 in which a telephone call is dialed using a text string, according to an embodiment. Preparatory to the call being made, an individual or business registers a suitable text string or alphanumeric corresponding with their telephone number to the telephone number look-up server 180. The telephone number look-up server 180 determines whether the requested text string is unique by consulting the database 185. If it unique (not found), an entry with the text string and corresponding telephone number is added to the database 185. After disseminating the text string to the public, a caller uses his or her smart phone 120 to place a call. In step 1, the smart phone 120 of the caller sends the text string to the telephone number look-up server 180. In turn, the telephone number look-up server consults the database 185 for the telephone number corresponding to the text string. In step 2, the telephone number is sent from the telephone number look-up server 180 to the smart phone 120 of the caller. In step 3, the smart phone 120 of the caller uses the received telephone number to place (“dial”) the telephone number, so as to connect with phone of the callee. Notably, the phone of the callee needn't be smartphone. Instead, it could be landline telephone or a cell phone without other features.

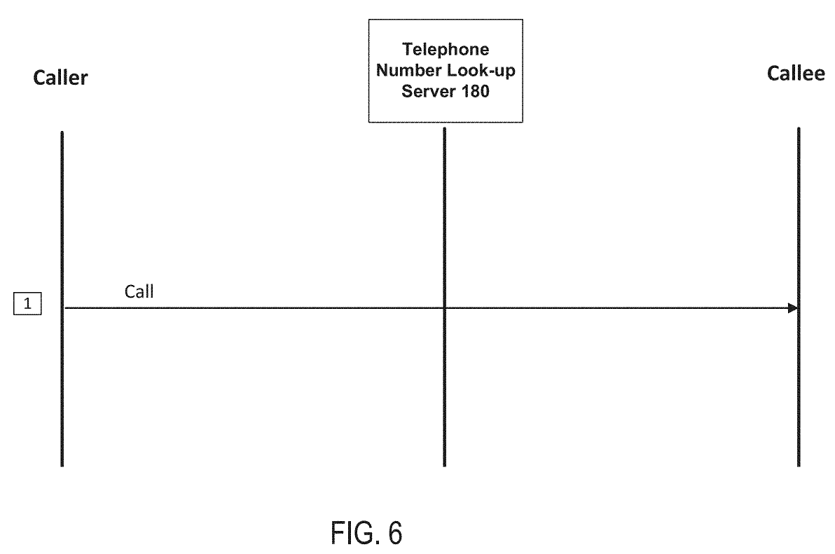

FIG. 6 is a diagram showing a method of using the text-based telephony system 100 in which a telephone call is dialed using a text string, according to another embodiment. The method of FIG. 6 differs from the method of FIG. 5 inasmuch that a subset of the database containing entries of text string and corresponding telephones is store in the memory 105 of the caller's smart phone 120. In this case, the caller enters the text string and the processor 103 executes instructions to look-up the entry in its local database stored in memory 105. Once a match is found, the corresponding telephone number is determined. In step 1, the call is placed using the numeric telephone number to the callee via telephony network 200. In this case, there is no need to consult the telephone number look-up server 180.

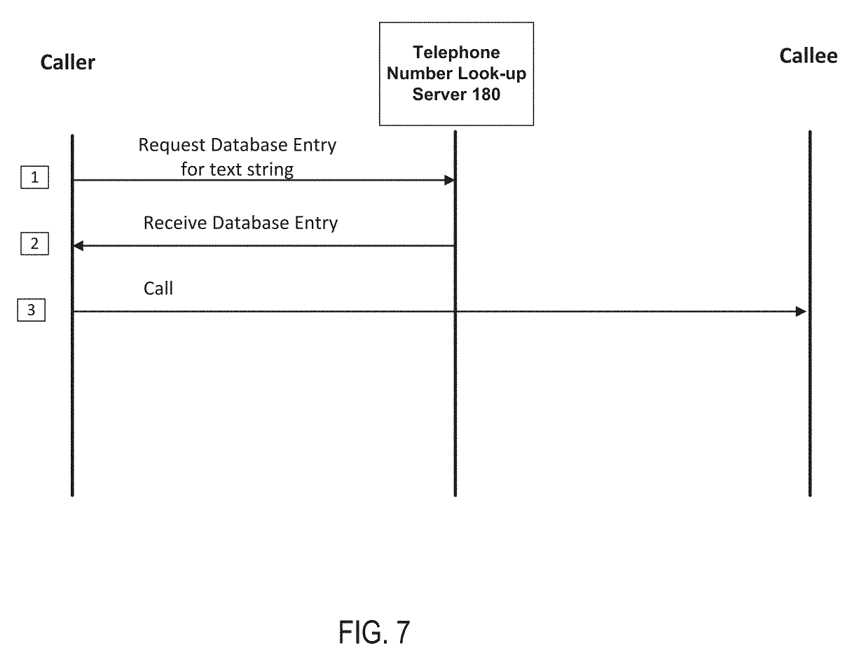

FIG. 7 is a diagram showing a method of using the text-based telephony system 100 in which a telephone call is dialed using a text string, according to another embodiment. The method of FIG. 7 differs from the method of FIG. 6 inasmuch that in this case an entry is not found in the local database stored in memory 105. Thus, in step 1, the smart phone 120 requests a database entry for the text string entered by the caller from the telephone look-up server 180. In step 2, the telephone look-up server 180 retrieves such information from database 185, and sends it to the caller's smart phone 120. The local database is updated. In step 3, the call is placed using the numeric telephone number to the callee via telephony network 200.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A text-based telephonic system, comprising:
a telephone number look-up server; and
a database, managed by the telephone number look-up server, containing entries for text strings and corresponding telephone numbers registered with the text-based telephonic system; and
wherein the telephone number look-up server includes a processor configured to retrieve a telephone number corresponding to a text string provided by a first phone connected via the Internet to the telephone look-up server from the database and provide the corresponding telephone number to the first phone;
wherein the provided telephone number is usable by the first phone to connect to a second phone via a telephony network.

2. The text-based telephonic system of claim 1, wherein the text strings are one or more alphanumeric strings.

3. The text-based telephonic system of claim 1, wherein the connection between the first phone and the second phone comprises a telephone call.

4. The text-based telephonic system of claim 1, wherein the telephony network is a public-switched telephone network.

5. The text-based telephonic system of claim 1, wherein the first phone is a smart phone and the second phone is a landline phone.

6. The text-based telephonic system of claim 1, wherein the telephony network is the Internet.

7. The text-based telephonic system of claim 1, wherein the first phone and the second phones are smart phones.

8. The text-based telephone system of claim 1, wherein at least part of the database is stored in memory of the first phone.

9. The text-based telephone system of claim 7, wherein the first phone consults a remote database if the provided text string cannot be found in the database stored in memory of the first phone.

10. The text-based telephone system of claim 1, wherein the text string provided by the first smart phone is found by a search engine query from a user of the first phone.

11. The text-based telephone system of claim 10, wherein the search engine provides a list of results related to the search engine query.

12. The text-based telephone system of claim 11, wherein the search engine results includes one or more image.

13. The text-based telephone system of claim 11, wherein the search engine results include personal information relating to one or more individuals.

14. The text-based telephone system of claim 10, wherein the search engine query includes a name of a person, company, or organization.

15. The text-based telephone system of claim 1, wherein the text strings relate to a product or service.

16. The text-based telephone system of claim 15, wherein the text strings relating to a product or service are registered trademarks.

17. The text-based telephone system of claim 1, wherein the text strings are unique.
